(19) United States
(12) Patent Application Publication
(10) Pub. No.: US 2014/0081658 A1
(43) Pub. Date: Mar. 20, 2014

(54) Computer-Based Analysis and Storage System for a Brain Rehabilitation Procedure

(71) Applicants: Henry S. Irving, Dallas, TX (US); Mary Ellen Hayden-Irving, Dallas, TX (US); Patrick M. Plenger, Double Oak, TX (US)

(72) Inventors: Henry S. Irving, Dallas, TX (US); Mary Ellen Hayden-Irving, Dallas, TX (US); Patrick M. Plenger, Double Oak, TX (US)

(21) Appl. No.: 13/789,437

(22) Filed: Mar. 7, 2013

Related U.S. Application Data
(60) Provisional application No. 61/608,037, filed on Mar. 7, 2012.

(51) Int. Cl. G06F 19/00

(52) U.S. Cl. CPC G06F 19/3481
USPC 705/3

(57) ABSTRACT

The present invention is a computer-based system that maintains test and evaluation data for TBI patients, computes more environmentally relevant brain rehabilitation evaluation scores, and provides appropriate graphical or numerical outputs for the system users regarding progress and prognosis of a TBI patient. The present invention also provides for an effective computer-based system for maintaining test evaluations for a brain rehabilitation procedure having environmental (such as distractions) and structure considerations, all as part of the assessment of an individual's overall function. The present invention also fulfills a need for providing a prognostic assessment for improvement potential relative to duration of treatment.

### CROSS REFERENCE TO RELATED APPLICATIONS

This application claims the benefit of U.S. Provisional Application No. 61/608,037 filed Mar. 7, 2012.

### TECHNICAL FIELD OF INVENTION

This invention relates to a computer-based analysis and storage system for use in a brain rehabilitation procedure for individuals with a traumatic brain injury (TBI).

### BACKGROUND OF THE INVENTION

Traumatic brain injury (TBI) is an injury to the brain resulting from a force applied either externally or internally, such that brain function is impaired, either temporarily or permanently. Brain injuries may be caused by an impact to the head, rapid acceleration or deceleration of the body, or penetration of the skull by a foreign object. TBI is generally classified based on the severity of the impairment experienced by the individual, and may range from mild, requiring little time or assistance to return to a fully functional status, to severe, with an individual having significant permanent impairment.

Recovery of functionality can require intensive treatment over a period of time. Initial levels of impairment and improvement over time must be measured to provide optimum patient care. A number of outcome measuring systems have been used in the past with varying amounts of success regarding correlation to a patient's actual recovery. Current neuropsychological measures have functional and ecological limitations with the most notable limitation in that they are structured to be given in a controlled testing environment. Specifically, they exclude extrinsic factors of distraction and provide an optimally structured testing environment.

The testing environment used for current neuropsychological measures, which is highly structured for consistent results, having a very low level of distractions to allow the best possible performance, is not the type of environment an individual will encounter upon discharging from treatment (Kim et al 2000). These known measures are relevant to determining initial levels of impairment, but are not consistently predictive of success in the real world.

Previous studies of naturalistic distractions in an otherwise structured environment have shown that people with TBI demonstrated more off-task behaviors than controls (Whyte et al 2000). This may be due to the high rate of executive dysfunction seen in the TBI population (Levine et al 2000), and so there is a need for executive dysfunction and off-task behaviors need to be a crucial part of any outcome measurement. Because of limitations in outcome measures, Bogdanova and Verfaellie (2012) discussed the need for developing a functional outcome measure that can be used in both acute and post-acute settings. Besides lacking ecological relevance to the patient, common outcome measures also require specific guidance for completion of the measure, and when the measure should be taken (Nichol et al 2011).

Other outcome measures, like the Disability Rating Scale, allow for measurement across the continuum of recovery, but do not address specific environmental features that may affect outcome. The Disability Rating scale also shows a marked ceiling effect when applied post-acutely. The Mayo-Portland Adaptability Inventory (MPAI-4) is an effective measure of outcome following acquired brain injury in a post-acute setting. The MPAI-4 consists of three indices based on 30 items measured by consensus of professional staff which takes approximately 20-30 minutes, and has demonstrated sensitivity to the effects of post-acute rehabilitation interventions, but the MPAI-4 does not address specific environmental features that may affect outcome.

The Functional Independence Measure (FIM) is a well-established measure for addressing the burden of care and level of disability in the TBI population, but FIM focuses on basic abilities and activities that are addressed primarily during in-patient rehabilitation. Like the DRS, the FIM shows a marked ceiling effect when administered post-acutely. Although these outcome measures are reliable and valid, these measurements do not assess the influence of environmental factors on performance both during rehabilitation and after discharge.

Previous studies have also discussed the importance of frontal lobe deficits, particularly in TBI (traumatic brain injury), with respect to how survivors function within the environment. (Hayden et al., 2000; Hart, T. & Jacobs, H. E., 1993). Two characteristics, in particular, tend to affect functioning in the environment by individuals with frontal lobe injury: information processing and executive dysfunction.

Information processing deficits appear to affect performance by making individuals vulnerable to the type and number of distractions in the environment. Executive functioning deficits tend to affect performance by increasing individuals' needs for external structure to function optimally. Hayden et al. (2000) discussed the importance of including environmental ratings in outcome measurement.

There is a need for computer-based system, which maintains test and evaluation data for TBI patients, computes more accurate brain rehabilitation evaluation scores, and provides appropriate graphical or numerical outputs for the system users regarding progress and prognosis of a TBI patient. A need also exists for an effective computer-based system for maintaining test evaluations for a brain rehabilitation procedure having environmental (such as distractions) and structure considerations, all as part of the assessment of an individual's overall function. A need also exists for a means of providing a prognostic assessment for improvement potential relative to duration of treatment.

### BRIEF DESCRIPTION OF THE DRAWINGS

FIG. 1 is a diagram of the computer server system 100 with its components,

FIG. 2 is a flow chart representation of the computer system,

FIG. 3 shows a graphical diagrams showing different initial PERPOS scores and average PERPOS score progression over time in the rehabilitation program,

FIG. 4 shows a graphical diagram showing an initial PERPOS score of 11 and trendlines and percentage chances for the different trendlines,

FIGS. 5A to 5I represents a different initial PERPOS Score plotted over weeks of treatment with trendlines and percentage chances for different trendlines,

FIGS. 6 and 7 are graphical diagrams shows the percentage of patients at each admitting PERPOS Score who have left treatment after the indicated number of weeks, and

FIGS. 8A to 8F are graphical diagrams showing PERPOS scores and trendlines at different time periods in the treatment schedule.

### SUMMARY OF THE INVENTION

Brain rehabilitation using directed recovery protocols and procedures show improved functional gains for individuals with TBI beyond that shown in undirected recovery. Postacute rehabilitation using a directed recovery procedure or protocol should be the standard of care after TBI. The present invention is a computer-based system supports a directed recovery brain rehabilitation protocol and procedure by maintaining test and evaluation data for TBI patients, computing more accurate brain rehabilitation evaluation scores, and providing appropriate graphical or numerical outputs for the system users regarding progress and prognosis of a TBI patient. The present invention also provides for an effective computer-based system for maintaining test evaluations for a brain rehabilitation procedure having environmental (such as distractions) and structure considerations, all as part of the assessment of an individual's overall function. The present invention also fulfills a need for providing a prognostic assessment for improvement potential relative to duration of treatment.

### DETAILED DESCRIPTION

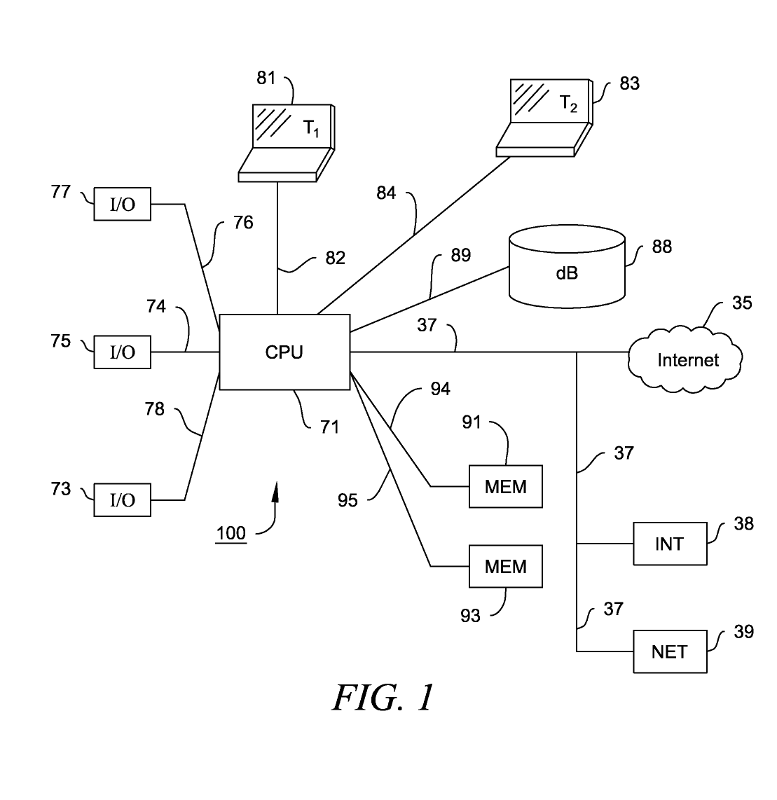

In FIG. 1, the computer-based server system 100 is shown. The computer system 100 is networked throughout its facilities to enter data into a system of linked databases, as well as being capable of remote access. A primary value of this computer system 100 is that, once entered into the data base system, hundreds of searches, comparisons, sorts, lists, and summaries are easily generated, allowing for comparison among many variables with internal historical data. The computer system 100 has continually been expanded and improved, and annual reports can be generated to summarize the Program Evaluation results for the calendar year. These results are reviewed by staff and management, and these reports are used in planning and development efforts for the coming year.

### The Computer System 100

Computer system 100 has central processing unit CPU 71 coupled to input/output units I/O 73, 75 and 77 via communication lines 78, 74 and 76, respectively. The I/O devices 73, 75, and 77 provide input and output information signals to the CPU 71. Terminals T1 81 and T2 83 are coupled to the CPU 71 via communication lines 82 and 84, respectively. Database memory 88 is coupled to the CPU via communication line 89. Additional memory 91 and 93 are coupled to CPU 71 via communication lines 94 and 95, respectively.

FIG. 1 is a block diagram of a server system 100 constructed in accordance with the present invention. In one embodiment, server system 100 comprises a CPU computing device 71; an input and output display subsystem 82 and 83 such as a keyboard or a mouse coupled to a computer display; a data storage 88 such as a hard drive database memory; other data storage 91 and 93 such as memory cards or memory storage; a network connectivity unit internal to the CPU 71 coupled to the Internet 35, communication interface 38 or other network interfaces 39. The memory 88, 91 and 93 hold operating software, web server software, and manager software.

Processing unit 71 comprises a microprocessor capable of executing stored program instructions. Input and output subsystem 82 and 83 (as well as I/O devices 73, 75 and 77) have circuitry for controlling input devices (for example a keyboard controller) and for performing signal conversions (for example, a digital signal processor) upon input data, as well as circuitry for operating upon and outputting data for display, for example a video card with processor, frame buffer, and display driver. Data storage unit 88, 91 and 93 may include both fixed and removable media based on storage technology such as magnetic, optical, or magneto-optical devices. Network connectivity unit in CPU 71 includes hardware and software for data communication in accordance with conventional protocols.

Memory 88, 91 and 93 includes both random access memory (RAM) and read-only memory (ROM), and provides storage for program instructions and data. Within the memory 88, 91 or 93, operating software comprises program instruction sequences for accessing, communicating with, and/or controlling auction server resources Operating software provides a software platform upon which application programs may execute, and web server software comprises program instruction sequences for responding to messages received via the Internet or other network. Manager software comprises program instruction sequences for inputting and loading data, maintaining data in a database, manipulating and analyzing data, and outputting graphical and numerical information. Computer manager includes interfacing and support for on-line website support, entry of information on-line, and the output of data on-line, which is all supported by the present invention. Conventional data input and output is also supported on the computer system.

The computer system 100 gathers and utilizes information from all patients served, from those knowledgeable about the patients, and/or from those who are advocates for the patient. Additional input to computer system 100 can be obtained from patients, family members, referral sources, physicians, and case managers, which is accumulated before treatment (including characteristics and funding sources), during treatment, and after treatment in a variety of ways. Information input into the computer system 100 can be retrieved and analyzed before and during treatment is implemented in a way that integrates the information into patient treatment plans to structure a program that is designed around the needs and expectations of the individual patient. Analysis, review, and implementation of resulting ideas from such input information provides a meaningful mechanism by which those served may have an impact on the organization's services, operations, and decision making.

The computer system 100 will maintain data collected in order to assist in the ability to meet the identified needs of past, current, and prospective consumers. Information from outcome measurement is managed and used in planning, modifying, adding, or deleting programs and services. Results of the evaluations are communicated throughout the organization via meetings and availability of written reports and, as appropriate, are shared with stakeholders in the community we serve.

In an exemplary embodiment of the present invention, the computer manager and server system has a computing device having at least one Intel Pentium IV (Intel Corporation, Santa Clara, Calif.) microprocessor; 2048 megabytes of random access memory (RAM); an internal hard disk drive and redundant drive; and at least one modem or network interface card. Microsoft Windows (Microsoft Corporation Redmond, Wash.) may serve as operating software with Microsoft Internet Information Server serving as web server software.

The database memory 88 maintains the records of the patients tested, observed and analyzed according to the PERPOS brain evaluation and analysis system, and the database memory 88, alone or in conjunction with memory MEM1 91 or MEM2 93, is used to coordinate patient data input, the evaluation, analysis, and manipulation of that data, and the output display or printing of that information as input or as manipulated by the computer-based program. The server computer system 100 has a database memory 88 for maintaining and managing data regarding each patient in the system, as well as the identification and approval of authorized personnel capable of accessing, inputting and outputting data from the system.

The computer system 100 can send information to remote or local client computers, user computers, and member computers on the network or Internet connected. The information sent from the server computer can be formatted in the form of a Web page written in Hyper Text Markup Language (HTML). The client, user and member computers can display the information on the auction in the form of a Web page, using a World Wide Web (WWW) browser, or other suitable display formatting on a local or remote computer.

The database memory 88 stores personal information on patients, for example, the patient names, addresses, patient records, accident reports, and test results, past or present performance on testing, as well as analysis of median and mean averaging of all patient performance over time. The patient ratings for functioning, structure and distraction testing is stored, as well as the manipulated PERPOS scoring based on those ratings applied to the PERPOS equation algorithm that computes a score based on emphasis of certain testing scores over others. Authorized personnel, including passwords and login, are also stored on the database memory 88 of the server computer system 100.

Communications to and from the system are regulated by the CPU 71 through the I/O 77, 75 or 73, or in the alternative, through the interface 37 coupled to the CPU 71 and the Internet 35, outside network connection NET 39, or communication interface INT 38. As shown in FIG. 1, the present invention supports a system and method for providing connectivity of a mobile node or other remote computer to one or more sources of information on the computer system 100.

Rating, Evaluation and Input of Data onto System

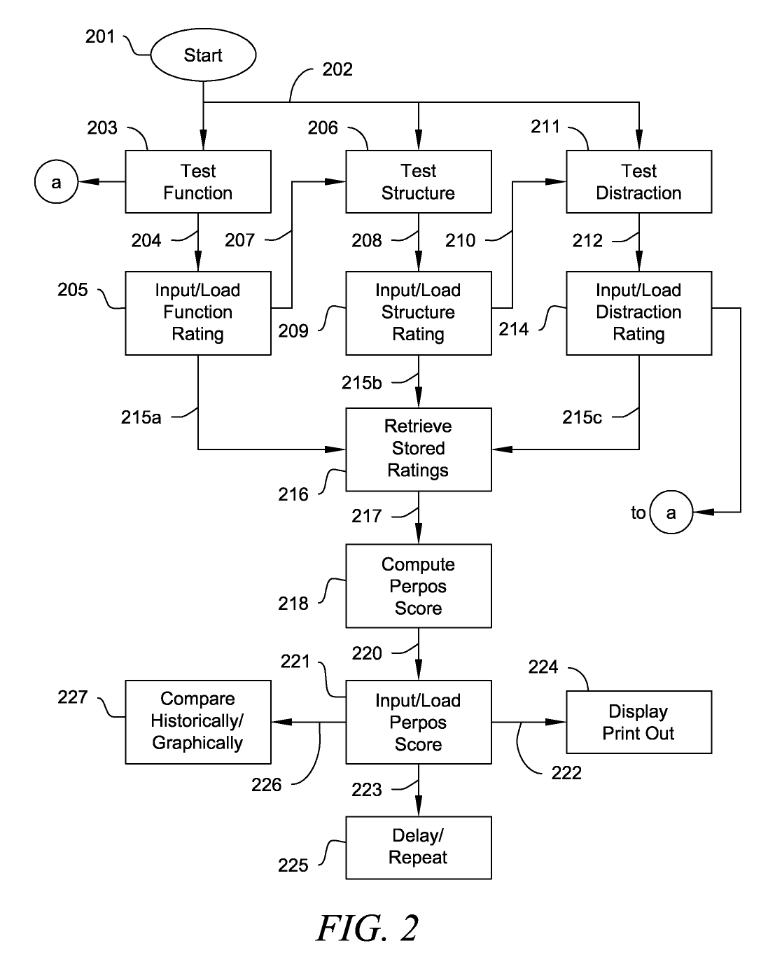

As shown in FIG. 2, the flowchart for the program operation on the server computer system 100 is shown starting at Step 201. Step 201 proceeds along transition step 202 to one of Steps 203, 206 or 211, which are function, structure, and distraction evaluations respectively. Any one of these steps may be chosen and conducted in any order, as long as all three tests are conducted.

Evaluation in each Step 203, 206 and 211 is based on objectively measured outcomes across multiple factors. One of the Program Evaluation components involves prognostic judgments about rehabilitation potential, which are made initially by the Admissions Committee and then by the treatment staff after their initial evaluation. Many factors are systematically tracked and measured, such as the level of distractions the patient can tolerate (Step 211), the level of external structure necessary for effective patient functioning (Step 206), and the progress toward specific functional goals, patient insight, etc. (Step 203).

At Step 203, the patient is tested for function, which entails an evaluation and analysis of the patient's overall functioning level (on a 1-7 scale of assistance), taking into account the environment of provided structure and distraction level. The function test rating is given based on the amount of staff participation versus patient independence is shown for function tasks as follows.

| | | |
|---|---|---|
| Total Assistance | 1 | Staff provide 75%-100% assistance; |
| | | Patient 0%-24% |
| Maximal Assistance | 2 | Staff provide 50%-74% assistance; |
| | | Patient 25-49% |
| Moderate Assistance | 3 | Staff provide 26%-49% assistance; |
| | | Patient 50%-74% |
| Minimal Assistance | 4 | Staff provide 0%-25% assistance; |
| | | Patient 75%-100% of task |
| | | independently; can complete task with |
| | | occasional cues in more than one area |
| | | or frequent cues in one area |
| Supervision | 5 | Requires set-up or occasional verbal cues |
| | | for only one aspect of task |
| Modified | 6 | Assistive devices, adaptive equipment, |
| Independent | | or extra time needed |
| Independent | 7 | Can complete tasks independently without |
| | | assistance |

The function test rating uses a higher ADL rating and patient insight as a guide on the 7 point scale. Other factors considered in arriving at the function test rating include the following:
(1) Community Mobility factors based on visual motor reaction; motor programming; visual scanning; motor speed/dexterity; attention/concentration; judgment/reasoning; topographical orientation; gait or wheelchair mobility on all surfaces; interpretation and utilization of abstract and inferential information,
(2) Basic ADLs factors based on grooming; bathing; dressing; toileting; eating; transfers; motor planning/sequencing; communication of basic needs and ability to comprehend simple requests; attention/concentration (able to sustain attention for short periods needed to perform activities such as taking a bath); simple problem-solving related to basic ADLs (able to perform simple sequencing necessary for performance of ADLs, etc); orientation (not required to be fully oriented, but needs to be aware of location of items needed for performance of ADLs, such as closet/clothing, etc),
(3) Transitional Goal factors based on the level of assistance and/or supervision needed for the patient to safely live and function in a residential setting; skills necessary to safely transition to outpatient services,
(4) Higher ADLs factors based on moderate to complex problem solving (verbal and non-verbal); visual scanning; memory (verbal and non-verbal); information processing; visual construction/perception; mediation of distractions/interruptions; general overall orientation; maintenance of personal finances; meal preparation; safety with household chemicals and equipment; effective management of medication; attention to detail; judgment/reasoning; cognitive flexibility; impulsivity; initiation; planning/organization; use of strategies (if needed),
(5) Social/Behavior factors based on interpretation of humor/sarcasm; hyperfluency; turn-taking; mild to moderate speech and language deficits; judgment/reasoning; response to feedback; impulsivity; appropriate verbalizations; emotional liability; frustration tolerance; management of stress and pain; appropriate management of personal hygiene (physically able but unaware of the importance of personal hygiene),
(6) Medical Goal factors based on effective management of medication; self-monitoring of vital signs; properly responding to a medical problem; seizure management; managing diabetic condition; managing edema; bowel and/or bladder incontinence; managing wound care; managing anticoagulant therapy; managing chronic pain; managing vertigo; others as defined; compliance with diet and swallowing precautions/strategies,
(7) Patient Insight factors based on independent use of strategies as warranted; able to identify cognitive strengths and weaknesses; ability to identify functional ramifications of cognitive strengths and weaknesses,
(8) Caregiver Insight factors based on caregiver's ability to identify patient's cognitive strengths and weaknesses; able to identify the functional ramifications of the patient's cognitive strengths and weaknesses; realistic about patient's functioning and future goals; follow-through on team requests and recommendations, and,
(9) DARS Vocational factors based on identification and pursuit of appropriate vocational goals; timesharing; ability to follow a schedule; timeliness; proper body mechanics as warranted; job-keeping behaviors; all performance criteria in higher ADLs and executive functioning.

At Step 206, the patient is tested for structure, which entails an evaluation and analysis of the patient's ability (on a 1-4 scale of assistance) need for structure to perform tasks such as initiation, organization, flexibility, and problem solving; internal “secretary” or “manager” tasks; their ability to do time management, keep appointments, schedule future appointments, follow a daily schedule, follow up on assigned tasks/activities/projects, self-advocate, and engage in timely communication with staff, caregivers, and other stakeholders.

| | | |
|---|---|---|
| Very High | 1 | Staff provides 50%-100% of structure; Patient 0%-49% |
| High | 2 | Staff provides 25%-49%; Patient 50%-75% |
| Moderate | 3 | Staff provides 5%-24%; Patient 76%-95% |
| Low | 4 | Staff provides 0%-4%; Patient 96%-100% |

Also, in the structure evaluation at Step 206, the patient's ability to determine steps to take in a given situation and to apply strategies without cues is examined and evaluated, but this evaluation does not include physically adaptive equipment (such as motorized wheelchair, communication device, etc.). The key to the structure rating is their level of “cognitive guidance” via frontal-executive functioning.

At Step 211, the patient is tested for distraction, which entails an analysis and evaluation of the patient's ability (on a 1-4 scale of assistance) to manage competing demands on their senses and internal cognitive states and maintain optimal functioning.

| | | |
|---|---|---|
| Very Low | 1 | Requires environment with essentially no auditory/ |
| | | visual stimuli; no interruptions |
| Low | 2 | Requires environment with only occasional auditory/ |
| | | visual stimuli; limited interruptions |
| Moderate | 3 | Tolerates frequent (but not constant) auditory/visual |
| | | stimuli and more interruptions |
| High | 4 | Tolerates constantly changing visual/auditory stimuli |
| | | and frequent interruptions |

In Step 211, the distraction rating is influenced by the patient's consistency in maintaining focused attention (or refocusing themselves) on physical or cognitive activities, despite external visual, auditory, or other external stimuli (e.g., people walking by, overheard conversations, visual stimuli in the environment, number of people in the room, general noise levels, clutter) and avoid internal distractions to the extent that can be discerned, such as fatigue, hunger, toileting needs, etc. Patients who perform poorly even in a Very Low distracting environment (e.g., those with poor initiation) are rated as a “1”.

TBI encompasses a wide range of possible levels of: (1) severity in neurological dysfunction (such as patients who have had extensive periods of coma to those with brief periods of altered consciousness), (2) acuity (such as patients still in post traumatic amnesia to those who are multiple years post injury), (3) anticipated level of functioning at discharge (such as those who will require 24-hour supervision to those who are returning to work as a physician, etc.). The seven-point scale which is applied to Overall Functional Level, specific subcategories of functioning, and Family Insight is, therefore, a relative (rather than an absolute) scale.

For each patient, the meaning of ratings on the functional variables is embedded within a matrix of the “environmental descriptors” (i.e., Levels of Structure and Distractions). That matrix in the present invention is an attempt to reflect the environmental constraints that apply to each patient throughout their day-to-day life. More specifically, the environmental matrix and scores computed in the present invention should provide a picture of how much structure they will require in the clinic, at home, on the job or at school, etc., as well as the level of distractions they can tolerate in each of those settings.

After the evaluation and rating Steps 203, 206 and 211 are conducted, the program will input or load the evaluation ratings for each step into the computer system 100. Namely, Step 203 proceeds through transition step 204 to the input and loading Step 205, Step 206 proceeds through transition step 208 to the input and loading Step 209, and Step 211 proceeds through transition step 212 to the input and loading Step 214. Any of the Steps 203, 206 or 211 may be performed after the data and ratings from that step are input and loaded into the database 88 of the computer system 100, as shown by transition steps 207, 210 or step a from Step 214 to Step 203. The loading and input steps may be accomplished manually or by an electronic file or data transfer procedure.

### The PERPOS Score Computation

After the loading and input Steps 205, 209 and 214 are performed, the computer system 100 is programmed to retrieve the function, structure and distraction ratings stored in database 88 in Step 216. Steps 205, 209 and 214 transition to Step 216 via transition steps 215a, 215b and 215c, respectively. After the Step 216 retrieval of stored rankings for function, structure and distraction evaluations, the compute system 100 transitions to Step 218 via transition step 217. At Step 218, the computer system 100 computes the PERPOS score using a formula that weights certain rankings more than others.

PERPOS stands for Pate Environmentally-Relevant Program Outcome System. The PERPOS score is designed to be a clinically useful tool, as well as an outcome measurement system. The three basic elements which make up the PERPOS score are structure, distraction, and overall function rankings. The PERPOS score includes measurements for level of distraction and level of structure, along with a measure of overall functioning when determining the overall score.

To determine the PERPOS Score, the computer system 100 retrieves the patient's Structure score (1-4), Distraction score (1-4), and Overall Function Score (1-7) from database 88 in Step 218. Because environment is the major focus of this scoring system, the Structure and Distraction ranking values are added and then multiplied by a factor of 2. This score is then added to the Overall Function score to result in the PERPOS score. The formula reads as follows:

PERPOS Score=2*(Structure+Distraction)+Overall Function

Two variables (Level of Structure and Level of Distractions) are believed to provide the most ecologically relevant picture of patient functioning, and thus, the computer system 100 has been programmed to place greater weight on those two ratings in computing a PERPOS score.

These two ratings are more heavily weighted in terms of their importance in determining patient progress. If a patient progresses in their ability to function effectively in more distracting and less structured environments, it should be more ecologically important than if they gain a level in one or more functional levels. Therefore, we are currently assigning twice the weights to the environmental variables that we are assigning to the functional variables.

Each clinical team member is trained in the PERPOS scoring method and is mentored by senior staff until exhibiting proficiency on using the PERPOS scale. Unpublished data on inter-rater reliability using written vignettes shows very high reliability. The PERPOS scoring is performed by a multidisciplinary clinical team providing Cognitive Therapy, Physical Therapy, Occupational Therapy, and Speech and Language Therapy, with appropriately licensed therapists and doctors in each field providing the assessments.

The lowest possible score for PERPOS is a 5 (Dependent) and the highest score is a 23 (Independent). The ranges for a PERPOS score are summarized as follows.

PERPOS Score of 6-8: Severely impaired (Physically, cognitively, and/or behaviorally) for all activities. An individual with this score requires 24-hour supervision, sometimes more than one-on-one if severity is based on cognitive/behavioral problems. If the patient's condition does not improve, discharge planning will be highly complicated by intensity of care.

PERPOS Score of 9-11: Severely impaired (physically, cognitively, and/or behaviorally). The individual continues to require 24-hour supervision, although some individuals at this level may be left for a few minutes at a time (to brush teeth, etc.). The patient may still be in PTA. The burden of care is intensive.

PERPOS Score of 12-14: Individuals may be independent in basic ADLs (activities of daily living), but still require supervision for higher ADLs. Generally, extensive structure is needed to maintain task performance on tasks of any significant complexity.

PERPOS Score of 15-17: General supervision to independent for basic ADLs. Individuals require more supervision for higher ADLs. Individuals are not driving, but a few can use public transportation independently after having been trained extensively; a few work at significantly modified jobs.

PERPOS Score of 18-19: Generally independent for basic ADLs, and supervision of highest ADLs. Many individuals live alone with distant supervision. Half of the individuals in this group drive. Others rely on family or public transportation for community mobility. Approximately 50% work, generally at modified jobs.

PERPOS Score of 20-21: Able to use structures is independent for all ADLs, although supervision may be needed for large financial transactions. Half of the individuals are driving; approximately 70% are working, with 30% working at unmodified premorbid jobs.

PERPOS Score of 22 or higher: Capable of living alone although 16% have significant problems with judgment, insight and speed (by family report) which require distant supervision for highest level of ADL. Approximately 60% are driving for personal business. Approximately 70% of patients achieving a PERPOS Score of 22 return to work. Of those returning to work, approximately 70% return to previous jobs without modification or restrictions. An additional 14% could have returned to work, but chose not to do so, due to litigation, a desire not to take a modified job, phobia (after being attacked at work), and criminal activity. All students falling into this group returned to regular classes at school, with 25% showing increased difficulty in comparison to previous educational experiences.

The PERPOS scores were compared to outcome scores obtained using MPAI-4 (Mayo-Portland Adaptability Inventory—Fourth Edition). Table 1 shows Spearman correlations between MPAI-4 and PERPOS.

TABLE 1
Spearman correlations between MPAI-4 and PERPOS

| MPAI-4 | PERPOS | Function | Structure | Distraction |
|---|---|---|---|---|
| Total score | −.882 | −.856 | −.826 | −.789 |
| Participation | −.891 | −.857 | −.844 | −.776 |
| Attention/ | −.815 | −.720 | −.736 | −.790 |
| Concentration | | | | |
| Novel Problem | −.798 | −.775 | −.775 | −.671 |
| Solving | −.773 | −.711 | −.764 | −.662 |
| Initiation | | | | |

Brain rehabilitation using directed recovery protocols and procedures show improved functional gains for individuals with TBI beyond that shown in undirected recovery. Postacute rehabilitation using a directed recovery procedure or protocol should be the standard of care after TBI. The PERPOS score generated by the computer system 100 provides a more accurate evaluation of actual patient status, progress, and future prognosis than other known systems. The computer system 100 supports the evaluation of present patient capabilities and future prognosis in an accurate manner.

PERPOS scores correlated well with the MPAI-4, an established outcome measure for acquired brain injury. The PERPOS system considers additional critical assessment factors such as Structure, Distraction and Overall Function, consideration of which factors increases the predictive value of prognostic assessments for TBI patients, which is believed to be significantly better than any known or used evaluation system for TBI patients.

Analyses were conducted on 813 pairs of PERPOS and MPAI-4 scores. A strong correlation was noted between the overall PERPOS score and overall MPAI-4 (rho=−0.88). Significant correlations were also noted between the level of Distraction (from the PERPOS) and the Attention/Concentration item from the MPAI-4 (rho=−79). While individuals with TBI who were participating in post-acute rehabilitation were scored with each system. Scores were based on staff ratings during therapy and were further refined during team discussion. Scores ranged from a low of 5 (Dependent) to a high of 23 (Independent).

Correlations between the level of Structure (from the PERPOS) and the Novel Problem Solving and Initiation items from the MPAI-4 were also significant (rho=−0.77 and −0.76, respectively). Correlations were highest between the PERPOS composite score and the Participation Index from the MPAI-4 (rho=−0.88). Analysis of predictive validity revealed that admit PERPOS composite accounted for 48% of the variance of the discharge Participation index from the MPAI-4. Good psychometric properties have been demonstrated for individuals who have undergone rehabilitation with the Pate Environmentally-Relevant Program Outcome System.

Three-hundred ninety-four TBI patients who were participating in a post-acute brain injury treatment program were assessed with the PERPOS system of the invention. Of these, 58% were severe and moderately-severe in the range of limitation as measured by the MPAI-4.

Admission and Discharge PERPOS and MPAI-4 ratings were calculated on the same day and over the same time-frame of rehabilitation. Correlational analyses were conducted on 813 pairs of PERPOS and MPAI-4 scores. Strong correlation was observed between the PERPOS composite score and overall MPAI-4 score.

Significant correlations were also noted between the level of Distraction (on PERPOS) and the Attention/Concentration item (from MPAI-4) and between the level of Structure (on PERPOS) and the Novel Problem Solving and Initiation items (from MPAI-4). Correlations were highest between the PERPOS composite score and the Participation Index from the MPAI-4.

Admission PERPOS composite accounted for 48% of the variance of Discharge Participation index from the MPAI-4. Significant concurrent validity of PERPOS with MPAI-4 was also demonstrated. This underscored the importance of assessing environmental factors in outcome measurement and established the PERPOS system as a valid outcome measure for evaluating such factors.

The Structure and Distraction components from the PERPOS correlated well with items from the MPAI-4 that would support the content validity of these components. That is, Structure was correlated with both Novel Problem Solving and Initiation items, which would be subsumed under frontal-executive functioning, and Distraction was correlated with the Attention and Concentration item.

Limitations in other known assessment tools led to the creation of the PERPOS system. Applicants have developed a program that results in assessment of effective and efficient treatment for individuals who have acquired brain injuries. Applicants have measured and documented the progress of more than 4000 patients over the treatment time. That data now constitutes one of the largest databases in the country pertaining to brain injured patients.

While the PERPOS method cross-references well with other measurement systems, it should be recognized that the system of the invention is unique and cannot be applied to different treatment programs. Adequate training in the method of the invention is required for rehabilitation professionals to properly utilize the PERPOS score for prognostic assessment of patients with TBI.

After Step 218, the computer system 100 transition along transition step 221 to Step 221, where the computed PERPOS Score is stored in the computer system 100 database 88. The program progresses from Step 221 to Step 225 via transition step 223, where the program waits or delays a predetermined, set or adjustable time frame before repeating the programming by starting again at Start Step 201. The time frame can be, for example, repeated every two weeks, with the storage of function, structure and distraction rankings with each repetition of the evaluation steps. Moreover, the evaluation, testing and storage of evaluation rankings may be performed without computing a PERPOS score every time the evaluation is performed.

### Fans and Graphical/Numerical Output

Alternatively, the program may progress from Step 221 along transition step 222 to the historical and graphical comparison step of Step 227 via transition step 226, or transition from Step 221 to the display and print out Step 224 via transition step 222. These Steps 227 and 224 are important to the system and are accomplished with statistical programs and analysis (e.g. mean, median, quartiles, averages, etc.), as well as graphical programs, as each of these steps demonstrates to and prints up materials that provide patients and family members with relevant information regarding their current status, possible ranges of recovery and future prognosis for recovery.

Brain rehabilitation from TBI using directed recovery protocols and procedures show improved functional gains for individuals with TBI beyond that shown in undirected recovery. Postacute rehabilitation using a directed recovery procedure or protocol should be the standard of care after TBI. To assist with a “directed recovery,” patients and family members need to be informed about the patient's current status, the possible recovery ranges, and the future prognosis of the patient, which is accomplished by Step 224 print out step and/or Step 227 comparison step.

The PERPOS score generated by the computer system 100 provides a more accurate evaluation of actual patient status, progress, and future prognosis than other known systems. The computer system 100 supports the evaluation of present patient capabilities and future prognosis in an accurate manner, and Steps 227 and 224 support the directed recovery efforts with the patient. The system of the invention is designed to allow for measurement and/or modification of the individual's environment needed to maximize overall level of functioning.

In Step 227, the PERPOS Score is plotted on a FANS chart and compared to historical data to provide a prognostic assessment. The system of the invention is designed to allow for measurement and/or modification of the individual's environment needed to maximize overall level of functioning. FANS stands for Future Anticipated Neuropsychological Status, which is part of the present invention's environmentally-based measurement system for evaluating individuals with traumatic brain injuries.

Development of the Future Anticipated Neuropsychological Status (FANS) takes the PERPOS scoring system one step farther in that it provides a graphical representation of the patient's progress compared to historical scores of patients with the same diagnosis and PERPOS level at admission. Data in the FANS charts is plotted weekly. When a PERPOS score is not available for a week, the value for that week is interpolated from the data of the previous and following weeks.

PERPOS, combined with FANS, provides information regarding the level and speed of recovery in relation to the normative data, any unusual changes in functioning, and allows education and explanation with patients, families, insurance companies, and other involved parties. The combination of these two methods yields the tool necessary to link evaluation of impairment levels in an individual, including the effect of environmental factors, such as distractions and structure, with a prognostic assessment for improvement potential relative to duration of treatment.

The FANS system was developed as a tool for clinicians, patient families, and payor sources. With FANS, it is possible to track and easily compare the current patient progress as determined using PERPOS versus the progress of all prior patients with the same diagnosis. FANS also provides a tool to predict a patient's outcome based on the trajectory of previous patients. The development of the FANS tool was accomplished using a database of PERPOS scores from over 4000 patients.

All outcomes data is stored in an Alpha V database. Outcomes from over 4,000 patients were exported into the computer system 100. Once in the program, records were separated by diagnosis—TBI, CVA (Cerebrovascular accident), and other. The TBIs and CVAs were then sorted into different functional categories.

TBI:
PERPOS 5
PERPOS 6 & 7
PERPOS 8
PERPOS 9 & 10
PERPOS 11
PERPOS 12 & 13
PERPOS 14 & 15
PERPOS 16
PERPOS 17 & 18

CVA:
PERPOS 5, 6 & 7
PERPOS 8
PERPOS 9, 10
PERPOS 11
PERPOS 12, 13
PERPOS 14, 15
PERPOS 16, 17 & 18

Mathematical formulas were used within a computer program for computer system 100 to organize and sort the database records. Inclusion criteria were assigned to remove atypical data; for example, patients who had a therapy gap of five or more staffings (multi-disciplinary staff sessions) were eliminated. For the remaining patient records, PERPOS scores were entered into columns representing the admission date, first staffing, second staffing, and so on until discharge. Formulas were written to calculate the progress rate for each patient included in the file.

For each functional level, the data was divided into four quartiles based on progress rates using a computer-based program. These quartiles represented the FANS and were a graphical representation of the high and low scores for each of the patients in that functional level. These graphs represent the baseline FANS to be used for comparative purposes. An input sheet within each functional level was created in a computer program allowing staff to enter each new data point (PERPOS score) such that it appears as a line on the FANS graph.

At admission, a computer-based file representing the functional level of the admission PERPOS score is created for each new patient. As the patient progresses through therapy, each PERPOS score is entered into the input form and the data points are automatically graphed onto that patient's FAN.

The FANS allow the therapy staff to see the patient's progress visually and to compare that progress to the quartiles. This also allows the staff to see whether the patient is making reasonable progress and serves as an early warning if the patient hasn't progressed for several staffings in a row. The early warning allows staff to re-visit the patient's plan of care to determine if the course of treatment or patient goals needs to be revisited.

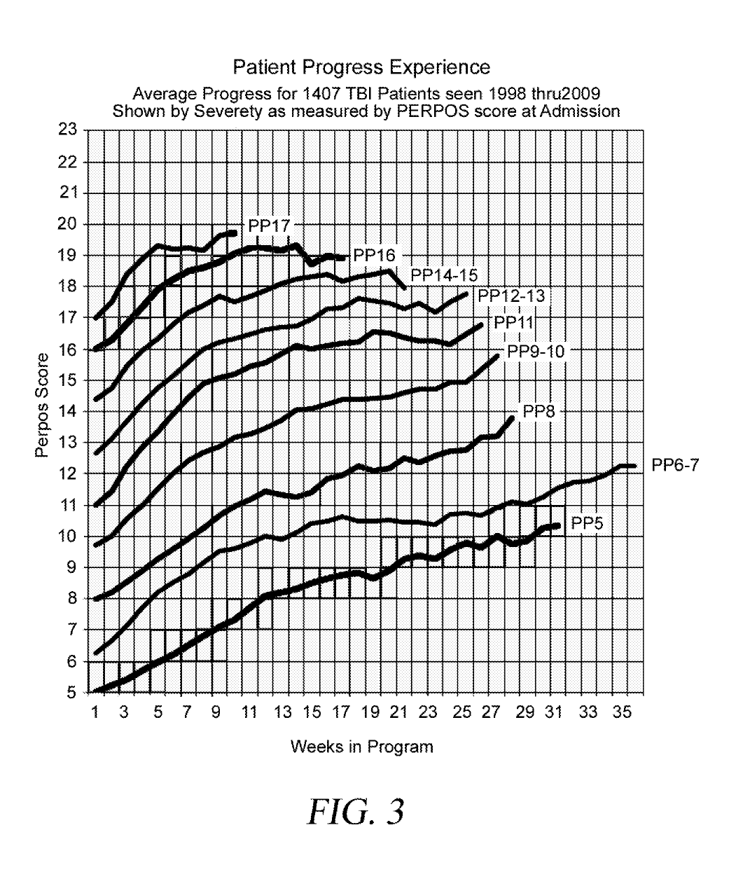

The PERPOS/FANS method may be understood by referring to the treatment outcome averages at different incoming TBI severity levels plotted against time in treatment as demonstrated in FIG. 3. The PERPOS score measuring the level of severity is plotted on the Y-axis against Time in treatment on the X-axis. Time in treatment may also be referred to as “length of stay” or LOS, and is measured in weeks. FIG. 3 charts 1407 patients beginning at week 1 of treatment. Some levels of severity are grouped as with PERPOS scores of 6 and 7.

As the weeks in treatment progress, the number of patients in each group decreases, based on individuals achieving goals, leaving the program or leveling off of progress. In the chart, the PERPOS Scores at different weeks refer to the average PERPOS Score of all patients remaining in treatment who began at the indicated severity level. For example, the average PERPOS Score of the 95 patients with an initial PERPOS Score of 11 was about 16 after 15 weeks in the program.

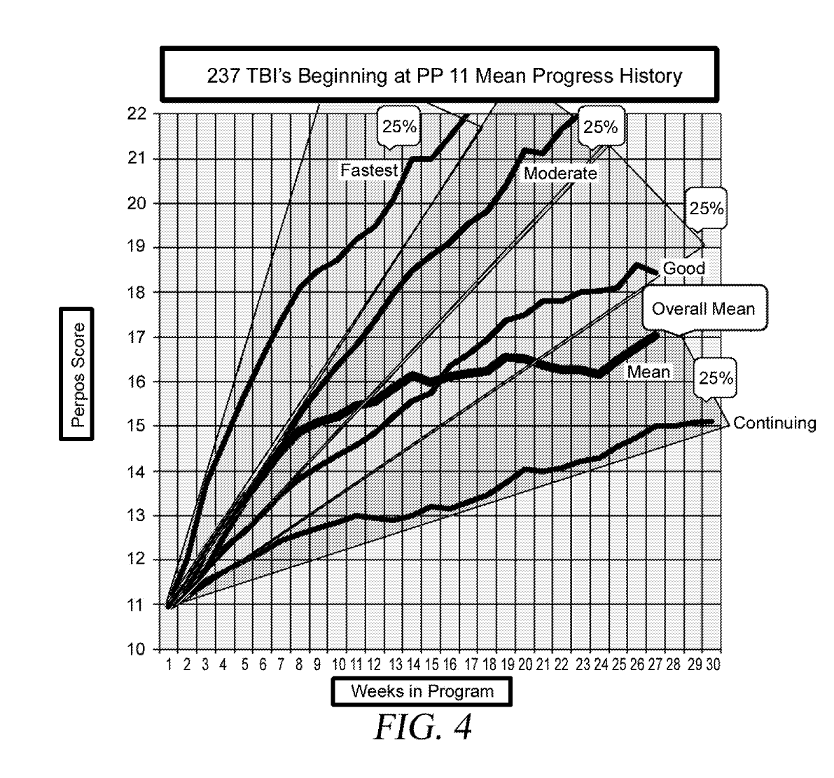

As can be seen in FIG. 3, patients entering the program at different severity levels progressed at different rates and achieved correspondingly different outcomes. Experience has shown that there is a wide variation in progress potential at each severity level. For that reason, each of the average curves in the above chart has been broken down in to 4 divisions of progress rate and outcome as demonstrated in FIG. 4. These averages do not account for many pre-injury status factors such as age, psychiatric issues, culture, sex, educational level, and work experience. Other factors which may affect the effectiveness of any treatment program include medical conditions such as seizures, diabetes, infections, etc.

In FIG. 4, the curve labeled “mean” corresponds to the curve beginning at PERPOS 11 (PP11) in FIG. 3. The mean drops as time goes on because after about 23 weeks, the mean is only averaging about 50% of the patients with the slowest progress. Those who progressed the fastest have already left the treatment program. All of the cases from PP11 have been split into four groups based on the rate of progress. Rate of progress as used here is equal to the change in PERPOS Scores divided by the number of weeks in treatment. The groups have been labeled arbitrarily as continuing, good, moderate and fast. Fast designates those who have progressed the fastest, and continuing designates those who have continued to make progress, but at a pace that puts them in the lower 25^{th} percentile of the progress rate.

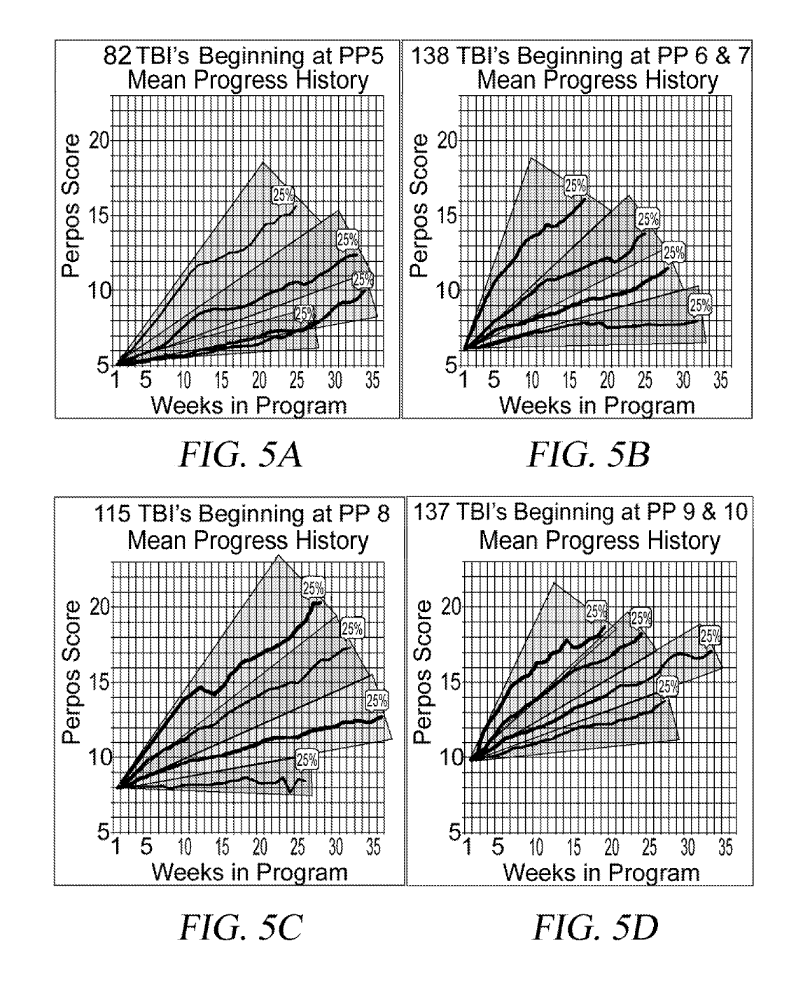

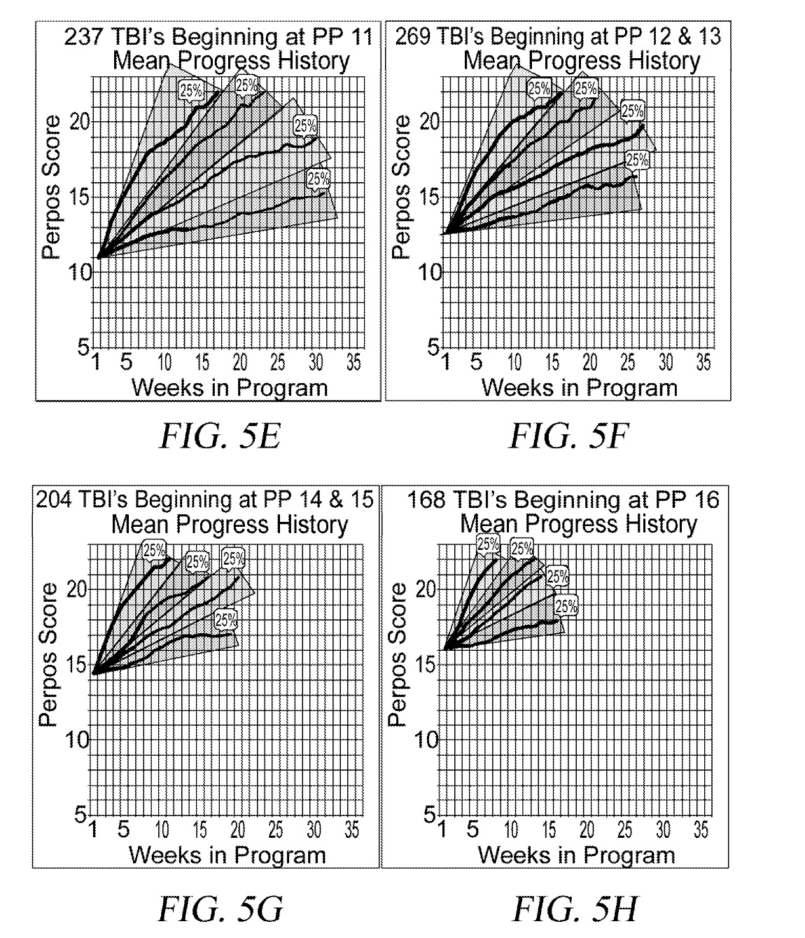

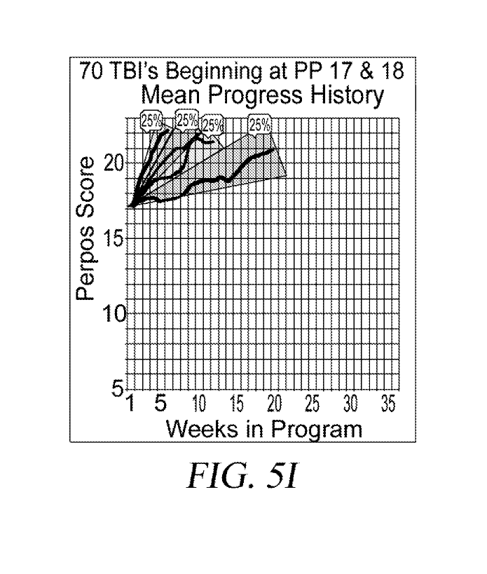

The “FANS” name also refers to the charts produced in Step 227 that have been developed to demonstrate nine different levels of impairment as seen in FIG. 5A to 5I. The fan divisions are not precise shapes that always represent the 25^{th} percentile, but are rather meant to indicate the approximate range each 25% spans. Each of these charts at FIGS. 5A to 5I represents a different initial PERPOS Score plotted over weeks of treatment (from initial PERPOS score of 5, 6, 8, 10, 11, 13, 14, 15, and 16, respectively), and graphically demonstrates several important points, such as: outcome goals and funding should be based on injury severity, and treatment needs vary significantly at any apparent injury level.

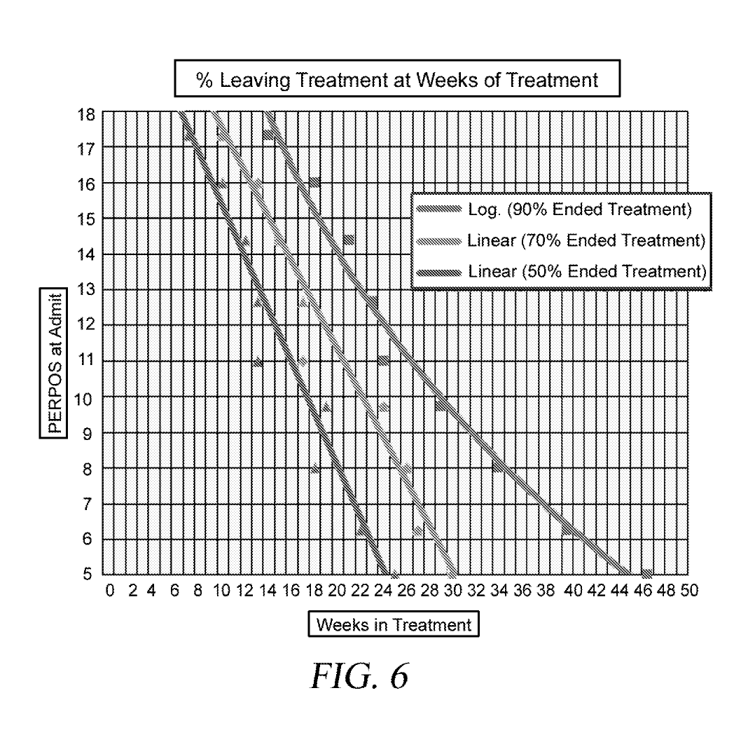

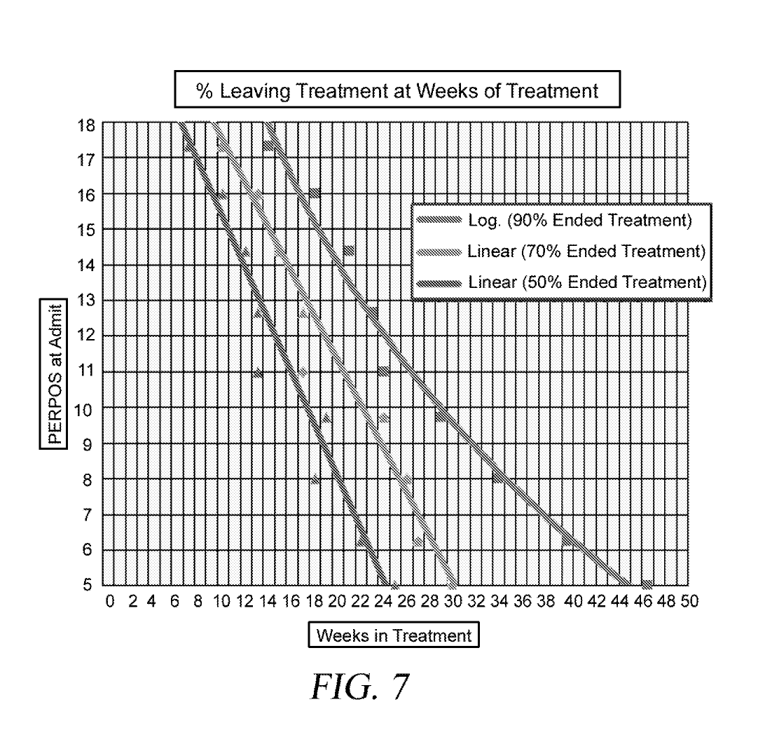

FIG. 6 shows the percentage of patients at each admitting PERPOS Score who have left treatment after the indicated number of weeks in treatment. The curves shown are computer-generated regression-type trendlines. For example, in FIG. 7, it can be seen that for patients beginning at a PERPOS Score of 8, 90% of these have left treatment at 34 weeks of treatment and about 50% have left at 20 weeks. Comparing this information with the PP8 FANS chart in FIG. 5A to 51, it can be projected that the additional weeks in treatment could allow 50% of the patients to improve another 3 to 4 levels. If patients beginning with a PP8 are only funded for 20 weeks, then 50% of those patients will not receive enough treatment to reach their recovery potential.

### Example 1

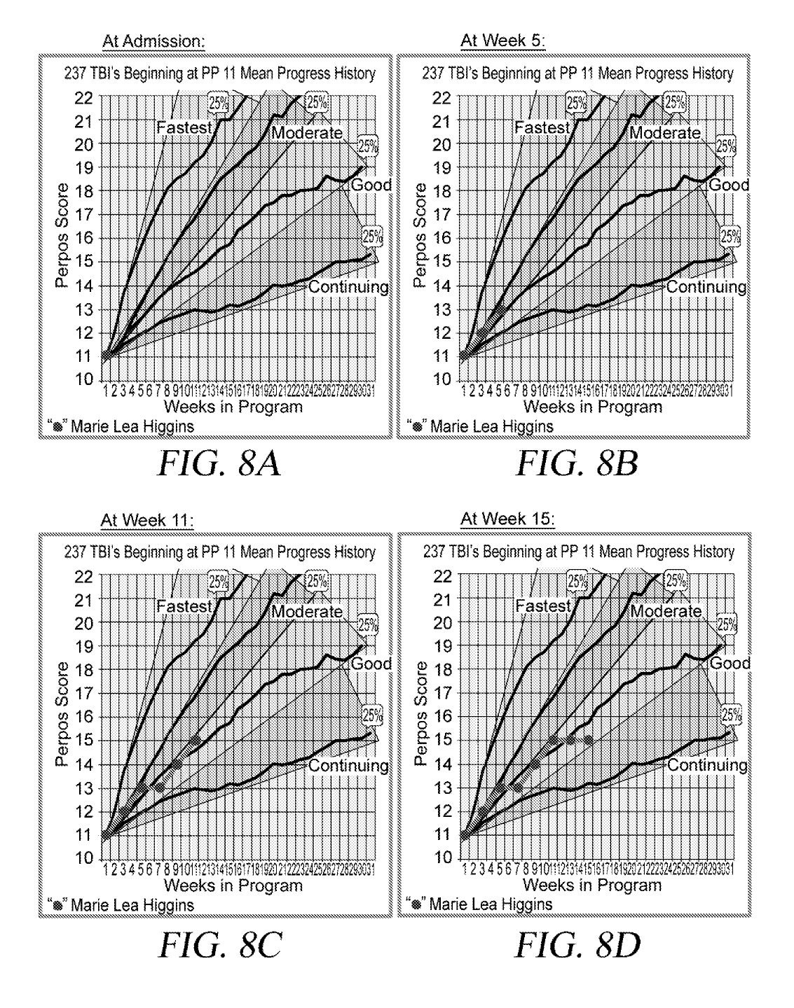

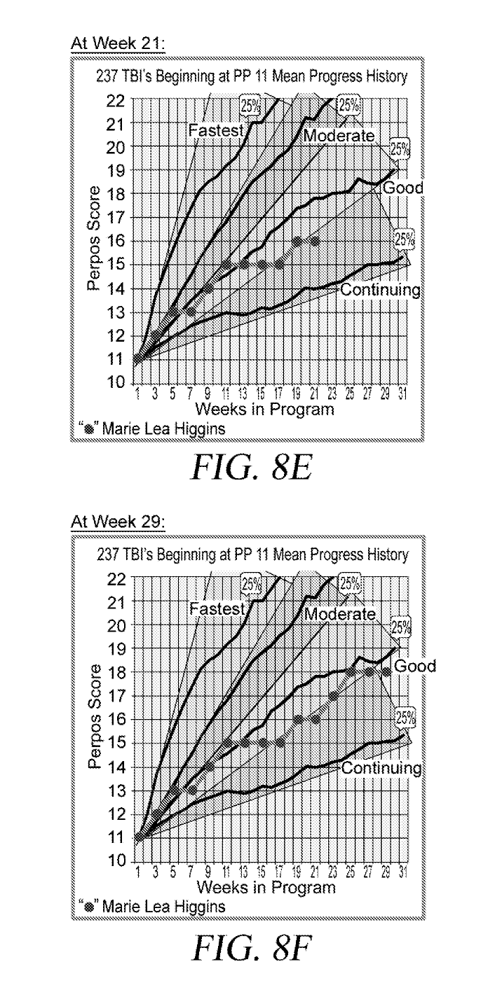

Example 1 below shows the process by which therapists and case managers can plan and monitor progress using FANS for a hypothetical patient “Marie Lea Higgins.” The charts in FIGS. 8A-8F explain considerations as treatment progresses.

FIG. 8A shows that, at admission, the initial PERPOS score for Marie was 11 (PP11). Based on the PERPOS/FANS database, approximately 87% of patients beginning at PP11 who remain in treatment are expected to achieve a discharge PERPOS Score between PP15 and PP22. The treatment time for approximately 75% of patients remaining in the program will vary from 17 to 31 weeks. As it is not known yet what to expect in Marie's case, funding should be requested for up to 31 weeks with the understanding that some cases will require more time and some will require less.

FIG. 8B shows that in the 5^{th} week of treatment, Marie's PERPOS Score (PP) has reached 13. This progress is approximately average for patients beginning at PP11. If this pattern continues, treatment might be expected to require treatment for about 24 weeks. The regular reports to payors and other stakeholders could reflect this status. Marie's progress record consists of 3 data points and shows progress; however, there is not enough data to make firm predictions about the extent of progress or overall timing.

FIG. 8C shows that in the 11^{th} week of treatment Marie's PP Score has reached 15. This is approximately average for patients beginning at PP11. Progress fluctuations have not been significant. If this pattern continues, the expected treatment time will still be 24 weeks as indicated in the previous assessment. Marie's progress record consists of 6 data points and shows progress. With this consistency, it is likely that progress would continue unless a significant factor appears that would cause unexpected change. Termination from the treatment at this point might result in some slippage as the impairment level has not yet stabilized.

FIG. 8D shows that in the 15^{th} week of treatment Marie's PP Score remained at 15. This pattern in not uncommon; however, since Marie has not shown progress over three staffings, the reasons should be analyzed more thoroughly than usual. Factors to consider include: Does the program need updating to be consistent with the patient's current level? Has there been a change in the patient's medical status? Has there been a change in patient attitude, i.e., discouragement, frustration, boredom or distraction? Are outside factors influencing the patient, i.e., funding issues, relationship issues, career issues, etc.?

FIG. 8E shows that in the 21^{st} week of treatment, Marie's PP Score is up to 16. This progress is slower than seen initially, but seems to be continuing. Considerations at this point should include the following: Expectations are that this patient will likely plateau at an impairment level of PP 16 to PP19. Goals should reflect this lower level of anticipated impairment. Discharge planning should be reviewed considering the revised goals. Analysis of results from MRI, CT and other sources should be reviewed to be sure impairment is consistent with such measurements and images. Innovative treatments should continue.

FIG. 8F shows that in the 29^{th} week of treatment, Marie's PP Score was up to 18. Considerations at this point should include the following: Were significant identifiable changes made at weeks 14 and 15 correcting stalled progress such that a few extra weeks in treatment are justified based on the stall problem being corrected? Most patients beginning at PP11 do not show much improvement beyond this number of weeks. Is the discharge plan ready? Another staffing without change would suggest discharge. Patients are individuals and cannot be treated according to group averages. It is therefore up to the treatment team to decide the action plan from here.

In the above hypothetical case of Marie Higgins, she would likely be discharged at PP18. If she were to re-enter treatment beginning at PP18, she would not be expected to follow the progress rates indicated by the progress charts for average patients beginning at PP18.

The assessment data in the PERPOS/FANS method provides significant information to stakeholders (that is, patients, family members, insurers, medical service providers, etc.) for understanding treatment timeframes and planning for future needs of an individual with a TBI. This includes initial goals, initial funding information, initial discharge expectations, and scope of treatment needed. The PERPOS/FANS method is a valuable tool for providing prognostic assessment of TBI patients.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

This disclosure is illustrative but not limiting; further modifications and embodiments will be apparent to those of skill in the art in light of this disclosure, and are intended to fall within the scope of the appended claims.

We claim:

1. A method for managing a computer-based rehabilitation program for traumatic brain injury patients performed comprising the steps of:
providing a computer system having input-output terminals, a central processing unit, one or more computer terminals, a database memory, and other associated memory;
assigning a rankings to a patient's level of distraction, structure, and overall function based on one or more assessments of the patient;
storing said rankings from the one or more assessments of the patient in the memory of the computer system;
retrieving rankings from the memory of the computer based on one or more prior assessments of the patient's level of distraction, structure and function;
computing an evaluation score with a weighted formula using the rankings retrieved from the computer memory, said weighted formula places emphasis on environmental factors;
storing the evaluation score in the memory of the computer; and,
using the evaluation score to provide a graphical output regarding the statistical analysis of the patient.

2. The method of claim 1 further comprising the step of:
plotting one or more evaluation scores on a graphical representation to show a progression of rehabilitation based on a comparison to historical data for the patient or other patients.

3. The method of claim 1 further comprising the step of preparing a prognostic assessment for the patient based on a correlation of one or more of said evaluation scores against historical data.

4. The method of claim 3 wherein said prognostic assessment is used in a treatment program for said patient.

5. The method of claim 1 wherein said patient is re-assessed on a periodic schedule.

6. The method of claim 1 wherein said treatment program for said patient is adjusted based on said graphical representation.

7. The method of claim 3 wherein said treatment program for said patient is based on said prognosis assessment.

8. The method of claim 1 wherein said weighted formula is (distraction ranking plus structure ranking) times 2 plus the function ranking.

9. A method for managing a computer-based rehabilitation program for traumatic brain injury patients performed comprising the steps of:
providing a computer system having input-output terminals, a central processing unit, one or more computer terminals, a database memory, and other associated memory;
assigning a rankings to a patient's level of distraction, structure, and overall function based on one or more assessments of the patient;
storing said rankings from the one or more assessments of the patient in the memory of the computer system;
retrieving said rankings obtained from the memory of the computer based on one or more prior assessments of the patient's level of distraction, structure and function;
computing an evaluation score with a weighted formula using the rankings retrieved from the computer memory;
storing the evaluation score in the memory of the computer; and,
using the evaluation score to provide a graphical output regarding the status, progress or prognosis of the patient based on historic and statistical analysis.

10. The method of claim 9 further comprising the step of:
plotting one or more evaluation scores on a graphical representation to show a progression of rehabilitation based on a comparison to historical data for the patient or other patients.

11. The method of claim 9 further comprising the step of:
preparing a prognostic assessment for the patient based on a correlation of one or more of said evaluation scores against historical data.

12. The method of claim 11 wherein said prognostic assessment is used in a treatment program for said patient.

13. The method of claim 9 wherein said patient is re-assessed on a periodic schedule.

14. The method of claim 9 wherein said treatment program for said patient is adjusted based on said graphical representation.

15. The method of claim 11 wherein said treatment program for said patient is based on said prognosis assessment.

16. The method of claim 9 wherein said weighted formula is (distraction ranking plus structure ranking) times 2 plus the function ranking.

17. A computer-based management system for rehabilitation program for traumatic brain injury patients comprising:
a computer system having input-output terminals, a central processing unit, one or more computer terminals, a database memory, and other associated memory, said input-output terminals receiving one or more rankings related to a patient's level of distraction, structure, and overall function based on one or more assessments of the patient, said memory storing said rankings from the one or more assessments of the patient in the memory of the computer system;
said computer system retrieving rankings obtained from the assessment of the patient's level of distraction, structure and function from the memory of the computer and computing an evaluation score with a weighted formula using the rankings retrieved from the computer memory for storage in the memory of the computer; and,
a graphical output generated by the central processing unit and output from the computer sight showing the status, progress or prognosis of the patient based on historic and statistical analysis of the patient's evaluation score.

18. The computer system of claim 17 wherein said central processing unit plots one or more evaluation scores on a graphical representation where progress rate is compared to historical data for the patient or other patients.

19. The computer system of claim 17 wherein said central processing unit prepares a prognostic assessment for the patient based on a correlation of said evaluation score against said historical data.

20. The computer system of claim 19 wherein said prognostic assessment is used in the rehabilitation treatment program for said patient.

21. The computer system of claim 17 wherein said patient is re-assessed on a periodic schedule.

22. The method of claim 17 wherein said treatment program for said patient is adjusted based on said graphical representation.

23. The method of claim 19 wherein said treatment program for said patient is based on said prognosis assessment.

24. The method of claim 17 wherein said weighted formula is (distraction ranking plus structure ranking) times 2 plus the function ranking.
